(19) United States
(12) Patent Application Publication
(10) Pub. No.: US 2025/0385973 A1
(43) Pub. Date: Dec. 18, 2025

(54) INFORMATION PROCESSING APPARATUS, CONTROL METHOD OF INFORMATION PROCESSING APPARATUS, AND STORAGE MEDIUM

(71) Applicant: CANON KABUSHIKI KAISHA, Tokyo (JP)

(72) Inventor: YOSHIHIDE TERAO, Kanagawa (JP)

(21) Appl. No.: 19/227,216

(22) Filed: Jun. 3, 2025

(30) Foreign Application Priority Data
Jun. 18, 2024 (JP) 2024-098346

(51) Int. Cl. H04N 1/00

(52) U.S. Cl. CPC H04N 1/0001; H04N 1/00029

(57) ABSTRACT

An information processing apparatus includes a network device, wherein the information processing apparatus executes transmission jobs for transmitting data to other apparatuses based on instructions from a user by using the network device, one or more memories storing instructions, and one or more processors capable of executing instructions causing the information processing apparatus to display, for each of the transmission jobs execution of which is instructed, information relating to each of the transmission jobs receive, of all pieces of the information, selection of a piece of information relating to a transmission job in which an error has occurred, diagnose the transmission job associated with the received information, and display a plurality of handling methods for the transmission job as a result of the diagnosis, wherein a handling method relating to link down is preferentially displayed, in the displaying of the plurality of handling methods.

### BACKGROUND

### Field of the Disclosure

The present disclosure relates to an information processing apparatus that diagnoses an apparatus.

### Description of the Related Art

When image data is transmitted to an external server or another apparatus, a transmission error may occur. Such a transmission error may be caused by authentication failure of an external server, an erroneous input of the host name of the external server, etc.

There are some inventions for presenting the causes of a variety of errors that have occurred during such transmission and corresponding handling methods to a user.

Japanese Patent Application Laid-Open No. 2018-086842 discusses a technique for displaying jobs that have resulted in errors as records and displaying handling methods for the errors.

To allow a user to grasp the cause of a job error and handle the error, there is proposed an information processing apparatus having a function of diagnosing a job that has resulted in an error.

When a job for transmitting image data, that is, a SEND job, results in an error, there are a plurality of possible causes for the error. It may be difficult for the user to determine which of the plurality of causes needs to be handled first.

### SUMMARY

According to an aspect of the present disclosure, an information processing apparatus includes a network device, wherein the information processing apparatus executes transmission jobs for transmitting data to other apparatuses based on instructions from a user by using the network device, one or more memories storing instructions, and one or more processors capable of executing instructions causing the information processing apparatus to display, for each of the transmission jobs execution of which is instructed, information relating to each of the transmission jobs receive, of all pieces of the information, selection of a piece of information relating to a transmission job in which an error has occurred, diagnose the transmission job associated with the received information, and display a plurality of handling methods for the transmission job as a result of the diagnosis, wherein a handling method relating to link down is preferentially displayed, in the displaying of the plurality of handling methods.

Further features of the present disclosure will become apparent from the following description of exemplary embodiments with reference to the attached drawings.

### BRIEF DESCRIPTION OF THE DRAWINGS

FIG. 1 is a system configuration diagram according to an exemplary embodiment.

FIG. 2 is an internal configuration diagram of a controller unit of a multifunction peripheral (MFP).

FIG. 3 is an internal configuration diagram of a controller unit of a file server and a mail server.

FIG. 4 is a block configuration diagram of software executed in the controller unit of the MFP.

FIG. 5 illustrates a data structure of job records.

FIG. 6 is a flowchart when error information is held.

FIG. 7 illustrates a screen for selecting a diagnosis content diagnosed by a diagnosis unit.

FIG. 8 illustrates a screen for selecting a job diagnosed by the diagnosis unit.

FIG. 9 is a flowchart for displaying a handling method list.

FIG. 10 illustrates a screen on which the handling method list is displayed.

FIG. 11 illustrates a screen on which a handling method relating to link down is not displayed.

### DESCRIPTION OF THE EMBODIMENTS

An exemplary embodiment will be described with reference to the drawings.

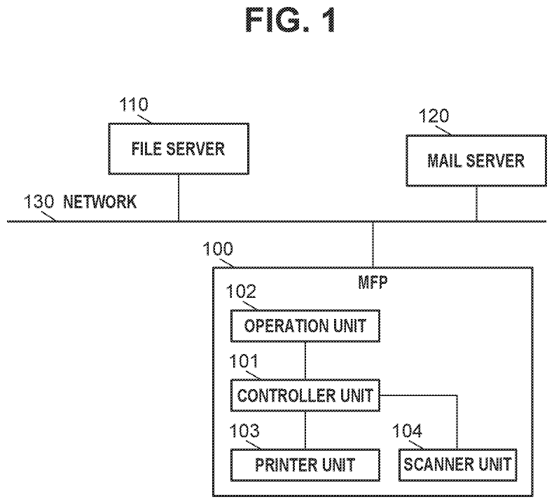

FIG. 1 illustrates an example of a system configuration according to the present exemplary embodiment. The system according to the present exemplary embodiment includes a multifunction peripheral (MFP) 100, an arbitrary file server 110, and an arbitrary mail server 120.

In the present exemplary embodiment, an MFP is used. However, any information processing apparatus that performs information processing may be used.

The MFP 100, the file server 110, and the mail server 120 are connected to each other via a network 130. Either a wired or wireless connection can be used for the network 130, and the network 130 may be either the Internet or an intranet. As long as data can be exchanged, any connection method, such as wireless connection, Wi-Fi, or a data communication line, may be used.

The MFP 100 is an image forming apparatus, which reads images with a scanner (a reading unit) and prints images. The MFP 100 includes an operation unit 102 that performs data input and output with a user. The MFP 100 includes a printer unit 103 that outputs electronic data onto a recording material. The MFP 100 has a scanner unit 104 that reads and converts the recording material into electronic signals. The operation unit 102, the printer unit 103, and the scanner unit 104 are connected to a controller unit 101, and implement functions as the multifunction peripheral in accordance with control instructions from the controller unit 101.

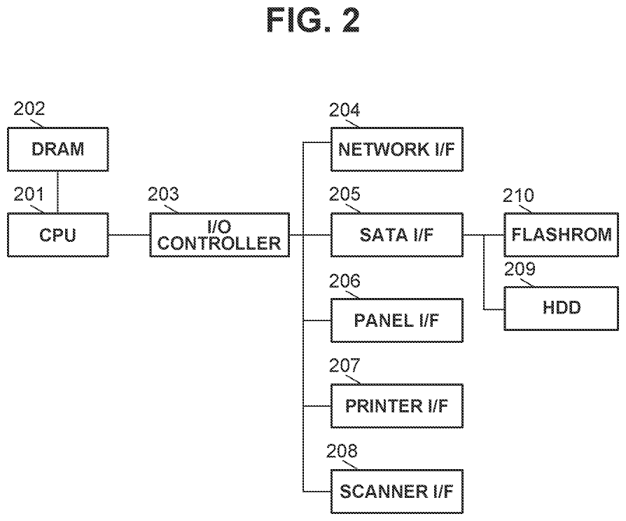

FIG. 2 is a block diagram illustrating details of the controller unit 101 of the MFP 100. A central processing unit (CPU) 201 performs main arithmetic processing in the controller unit 101. The CPU 201 is connected to a dynamic random access memory (DRAM) 202 via a bus. The CPU 201 uses the DRAM 202 as a working memory in which the CPU 201 temporarily stores program data representing operation instructions in the process of computation and data to be processed. The CPU 201 is connected to an input/output (I/O) controller 203 via a bus.

The I/O controller 203 inputs and outputs data to and from various kinds of devices in accordance with instructions from the CPU 201. A serial advanced technology attachment (SATA) interface (I/F) 205 is connected to the I/O controller 203, and a Flash ROM 210 and a hard disk drive (HDD) 209 are further connected to the SATA I/F 205. The CPU 201 uses the Flash ROM 210 and the HDD 209 to persistently store programs and document files for implementing the functions of the MFP 100. A network I/F 204 is connected to the I/O controller 203. The network I/F 204 is a network device to which wired local area network (LAN) devices and wireless LAN devices are connected. The CPU 201 realizes communication on the network 130 by controlling the wired LAN devices and the wireless LAN devices via the network I/F 204. A panel I/F 206 is connected to the I/O controller 203, and the CPU 201 inputs and outputs data to and from the operation unit 102 for the user via the panel I/F 206. A printer I/F 207 is connected to the I/O controller 203, and the CPU 201 performs output processing on a recording material by using the printer unit 103 via the printer I/F 207.

The MFP 100 includes various kinds of applications for using its functions. Examples of the functions include a copy function and a transmission function (SEND function).

For example, when implementing the copy function, the CPU 201 reads program data from the Flash ROM 210 into the DRAM 202 via the SATA I/F 205. The CPU 201 detects a copy instruction entered by the user to the operation unit 102 via the panel I/F 206 in accordance with the program read into the DRAM 202. Upon detecting the copy instruction, the CPU 201 receives a document from the scanner unit 104 via the scanner I/F 208 as electronic data, and stores the electronic data in the DRAM 202. The CPU 201 performs color conversion processing, etc., suitable for the output on the image data stored in the DRAM 202. The CPU 201 transfers the image data stored in the DRAM 202 to the printer unit 103 via the printer I/F 207, and performs output processing onto the recording material.

When the transmission function is implemented, the CPU 201 detects a transmission instruction from the user in the same way as the CPU 201 detects a copy instruction from the user when the copy function is implemented. The transmission instruction includes a transmission protocol, a destination, an image format, etc., specified by the user. The transmission protocol is Server Message Block (SMB), file transfer protocol (FTP), or the like, and the destination is specified using, for example, the Universal Naming Convention (UNC). The image format is Joint Photographic Experts Group (JPEG), portable document format (PDF), or the like. Having detected the transmission instruction, the CPU 201 receives a document from the scanner unit 104 via the scanner I/F 208 as electronic data, and stores the electronic data in the DRAM 202. The CPU 201 performs image format conversion, etc., specified by the user on the image data stored in the DRAM 202. The CPU 201 transfers the image data stored in the DRAM 202 to the destination via the network I/F 204 by using the protocol specified by the user.

The above-described functions are examples of the functions of the MFP 100, and other functions may additionally be provided.

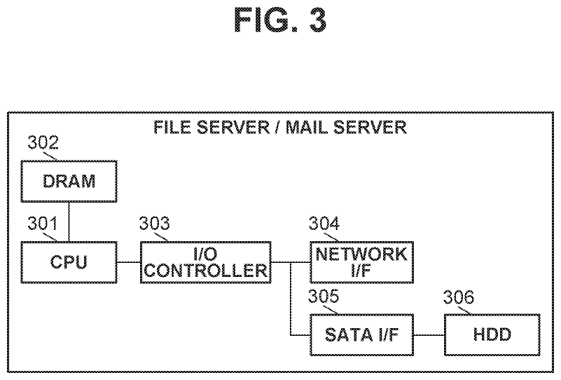

FIG. 3 is a block diagram illustrating details of the file server 110 and the mail server 120 according to the present exemplary embodiment. In the present exemplary embodiment, the file server 110 and the mail server 120 are illustrated as the same block diagram for the sake of simplicity. However, the file server 110 and the mail server 120 may have different configurations. A CPU 301 is connected to a DRAM 302 via a bus. The CPU 301 uses the DRAM 302 as a working memory in which the CPU 301 temporarily stores program data representing operation instructions in the process of computation and data to be processed. The CPU 301 is connected to an I/O controller 303 via a bus. A network I/F 304 is connected to the I/O controller 303. Wired LAN devices and wireless LAN devices are connected to the network I/F 304. The CPU 301 realizes communication on the network 130 by controlling the wired LAN devices and the wireless LAN devices via the network I/F 304. The I/O controller 303 inputs and outputs data to and from various kinds of devices in accordance with instructions from the CPU 301. A serial advanced technology attachment (SATA) I/F 305 is connected to the I/O controller 303, and an HDD 306 is connected to the SATA I/F 305. The CPU 301 executes a program relating to authorization processing when serving as a CPU in the authorization server, and executes a program relating to mail transmission and reception processing when serving as a CPU in the mail server. As described above, the hardware such as the CPU 301, the DRAM 302, and the HDD 306 are included in a computer. In the present exemplary embodiment, for the sake of description, a case where a single CPU 301 performs each step illustrated in a flowchart, which will be described below, by using a single memory (the DRAM 302) will be described as an example. However, a different configuration may be employed. For example, a plurality of processors, a RAM, a ROM, and a storage may be used in cooperation, so as to execute each step illustrated in the flowchart, which will be described below. Each step may be executed by using a plurality of server computers.

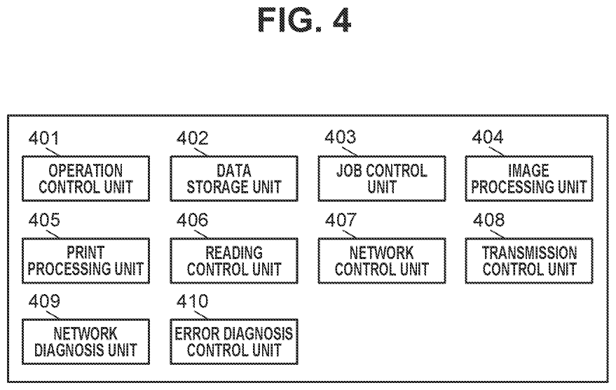

FIG. 4 is a block diagram illustrating a configuration of software executed by the controller unit 101 of the MFP 100. The software is executed on an arbitrary operating system (hereinafter, referred to as OS). The controller unit 101 executes all the software after the CPU 201 reads a program stored in the Flash ROM 210 into the DRAM 202. An operation control unit 401 displays a screen image for the user on the operation unit 102, detects a user operation, and executes processing associated with screen components such as buttons displayed on the screen.

A data storage unit 402 stores requests from other control units in the HDD 209 or the Flash ROM 210, and reads out the stored requests. A job control unit 403 controls the execution of jobs in accordance with instructions from the other control units. An image processing unit 404 processes image data into a format suitable for its intended use in accordance with an instruction from the job control unit 403. A print processing unit 405 prints and outputs an image on a recording material via the printer I/F 207 in accordance with an instruction from the job control unit 403. A reading control unit 406 reads a set document via the scanner I/F 208 in accordance with an instruction from the job control unit 403. A network control unit 407 inputs and outputs data to and from LANs and public line networks via the network I/F 204 in accordance with instructions from the control units. The data storage unit 402 allows external devices to access the data stored in the Flash ROM 210 via the network control unit 407. Examples of the data stored in the Flash ROM 210 include PDF images and JPEG images.

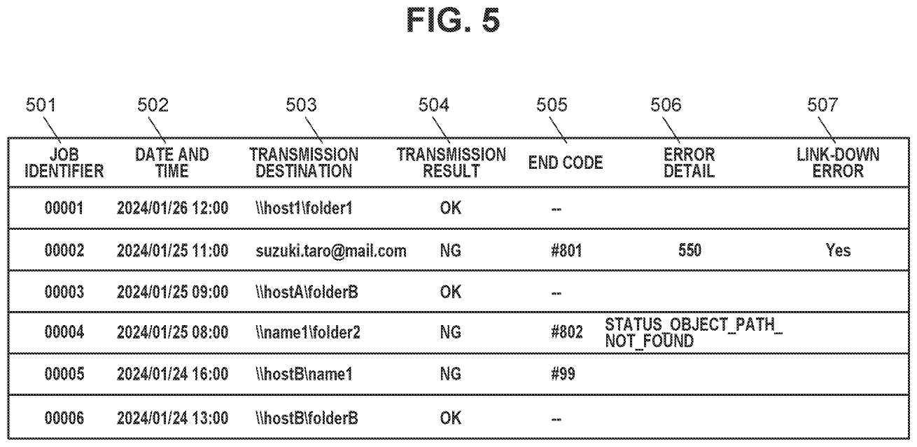

A transmission control unit 408 executes processing for transmitting image data or the like read by the reading control unit 406 to the file server 110 or the mail server 120 via the network control unit 407. The results of the executed transmission processing are stored in the HDD 209 via the data storage unit 402 as job records illustrated in FIG. 5.

FIG. 5 illustrates an example of a data structure of job records. A job identifier 501 is a unique number for uniquely identifying a job corresponding to a transmission result. Date and time 502 indicate the date and time when the transmission has been completed. A transmission destination 503 indicates information about the destination of the transmission. A transmission result 504 indicates information about whether the transmission has succeeded (SUCCESS) or failed (FAILURE). An end code 505 is a number indicating the cause of the failure. For example, “#801” indicates that communication with the server has failed for some reason, and “#802” indicates that transmission of image data to the server has failed for some reason. Further, “#99” indicates that the user has canceled the transmission. The job records represent records of transmission jobs that have transmitted data. However, the individual job record is not limited to the above example. The job record may be displayed such that a job in which copying has been executed by the copy function is included in the job record.

An error detail 506 holds detailed information about the cause of the transmission error. For example, “550” is stored as the error detail of the job that has ended due to “#801” during mail transmission. This code represents error information transmitted from the mail server 120 when the mail server 120 fails the transmission. Such a code is defined in each mail server. The details of the cause of the error (for example, the user name or password at the authentication is incorrect) can be obtained from this error information.

As the error detail of the job that has ended due to “#802” during file transmission, “STATUS_OBJECT_PATH_NOT_FOUND” is stored. This code represents error information transmitted from the file server 110 when the file server 110 fails the transmission. Such a code is defined in each file server. The details of the cause of the error (for example, the folder path of the transmission destination does not exist) can be obtained from this error information.

With regard to the job record indicating that the transmission has failed (FAILURE) due to “#99”, nothing is stored as the error detail because the user has cancelled the job corresponding to the job record.

A link-down error 507 holds information about whether link down of the network has occurred.

A network diagnosis unit 409 is a control unit for determining whether the network connection is in a link-down state, and whether or not the network connection is in the link-down state can be obtained via the OS.

An error diagnosis control unit 410 is a control unit for diagnosing the cause of the transmission error by using the job record data in FIG. 5.

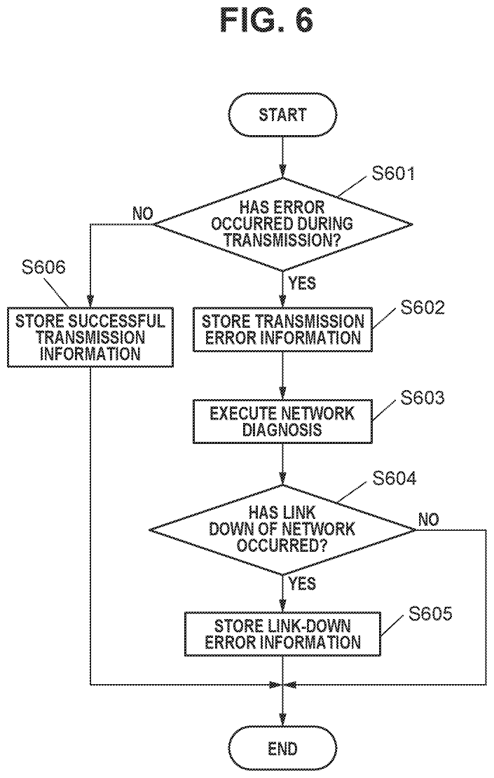

A job record data storage method according to the present exemplary embodiment will be described with reference to FIG. 6. This method is performed when a transmission job results in a transmission error. In the present exemplary embodiment, all the software executed in the MFP 100 in FIG. 6 is executed after the CPU 201 reads a program stored in the Flash ROM 210 into the DRAM 202.

In step S601, the transmission control unit 408 determines whether a transmission error has occurred when transmission to a given transmission destination has been performed.

In a case where the transmission control unit 408 determines that no transmission error has occurred in step S601 (NO in step S601), the process proceeds to step S606. In step S606, information indicating that the transmission has succeeded (SUCCESS) is stored in the transmission result 504 of the job record data, and the process proceeds to END.

In a case where the transmission control unit 408 determines that a transmission error has occurred in step S601 (YES in step S601), the process proceeds to step S602. In step S602, information indicating that the transmission has failed (FAILURE) is stored in the transmission result 504, and as necessary, information about the error detail 506 is stored in the job record data.

In step S603, the transmission control unit 408 requests the network diagnosis unit 409 to diagnose the network. The network diagnosis unit 409 obtains information about whether or not the network connection is in the link-down state via the OS, and sends the network diagnosis result to the transmission control unit 408.

In step S604, the transmission control unit 408 checks the network diagnosis result obtained in step S603. In a case where a link-down error has not occurred (NO in step S604), the process proceeds to END.

In step S605, the transmission control unit 408 stores information indicating that link down has occurred in the link-down error 507 of the job record data, and the process proceeds to END.

A diagnosis unit according to the present exemplary embodiment that diagnoses a job in which an error has occurred will be described.

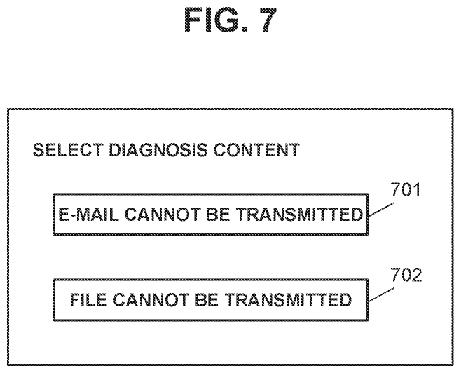

The diagnosis unit is operated from a screen that is displayed, as illustrated in FIG. 7, on the operation unit 102 via the operation control unit 401.

FIG. 7 illustrates an example of the screen on which a diagnosis content diagnosed by the diagnosis unit is displayed. An option 701 or an option 702 can be selected as the diagnosis content. The number of options is not limited to two. More options may be displayed. In FIG. 7, only the diagnosis contents relating to a transmission job are displayed. However, the diagnosis contents are not limited to the example, and it is preferable to include diagnosis contents relating to a copy job in the options.

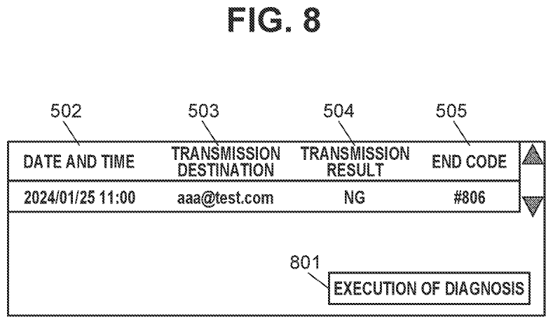

When the option 701 is selected, a first display unit displays a screen as illustrated in FIG. 8. The first display unit displays, among the job records in FIG. 5, a list of job records in which the transmission destination 503 is an e-mail destination and the error detail 506 exists. In FIG. 8, one transmission job is displayed by the first display unit. However, if there are a plurality of transmission jobs in which an error has occurred, the first display unit displays the plurality of transmission jobs. The first display unit displays all the transmission jobs in which an error has occurred.

Similarly, when the option 702 is selected, the first display unit displays, among the job records in FIG. 5, a list of the job records in which the transmission destination 503 is a file destination and the error detail 506 exists.

In FIG. 8, information relating to the transmission job, such as the date and time 502, the transmission destination 503, the transmission result 504, and the end code 505, is displayed in association with each transmission job.

In FIG. 8, a reception unit receives, from the user, one piece of information (icon) relating to an arbitrary transmission job of all the displayed pieces of information. After the reception unit receives the one piece of information, the diagnosis by the diagnosis unit is executed by pressing execution of diagnosis 801.

The operation of the diagnosis unit will be described.

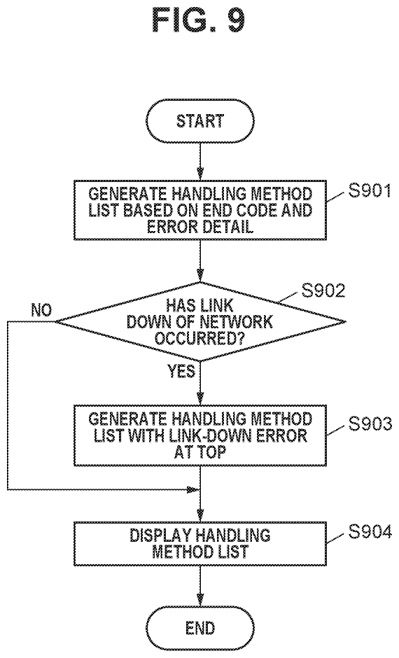

The diagnosis unit according to the present exemplary embodiment will be described with reference to FIG. 9. In the present exemplary embodiment, all the software executed in the MFP 100 in FIG. 9 is executed after the CPU 201 reads a program stored in the Flash ROM 210 into the DRAM 202.

In step S901, the error diagnosis control unit 410 generates a list of handling methods for the error causes based on the contents of the end code 505 and the error detail 506 stored in the information selected in FIG. 8. The error diagnosis control unit 410 determines the priority of the error causes to be displayed based on the content of the error detail 506.

In step S902, the error diagnosis control unit 410 determines whether link down of the network has occurred by referring to whether error information is included in the link-down error 507 stored in the information selected in FIG. 8.

In step S903, the error diagnosis control unit 410 adds the link-down error to the top of the list of handling methods generated in step S901.

In step S904, the error diagnosis control unit 410 causes the operation control unit 401 to display the handling methods generated in step S903 on the operation unit 102 (a second display unit).

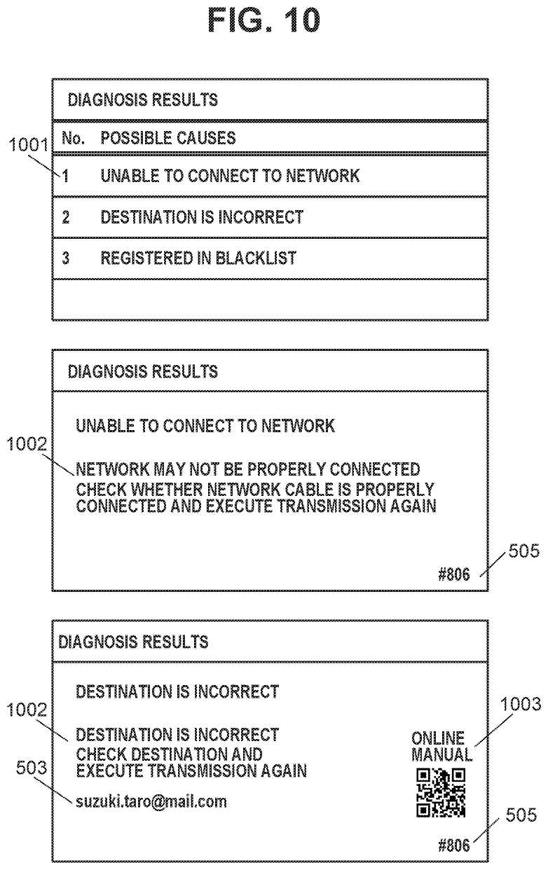

FIG. 10A illustrates an example of the list of handling methods displayed by the second display unit. The cause indicating that link down of the network has occurred is displayed at the top of a list 1001 of handling methods. The number “1” is assigned to the cause “unable to connect to the network” displayed at the top.

In the present exemplary embodiment, three handling methods are displayed. However, the number of handling methods is not limited to three. Three or more or less than three handling methods may be displayed.

When one of the handling methods is selected, a screen on which the details of the selected handling method are described is displayed. FIGS. 10B and 10C are examples of such screen. FIG. 10B illustrates an example of the screen when the cause “unable to connect to the network” is selected in the list 1001. The screen displays the cause of the error, an error handling method 1002, and the end code 505.

The diagnosis unit performs diagnosis based on the end code in the selected information. Accordingly, the diagnosis unit diagnoses the state of the apparatus at the time when the transmission job associated with the selected information has been executed.

That is, even if the network cable is correctly connected at the time of the diagnosis, the second display unit displays the handling method relating to the link down, that is, “unable to connect to the network”. In other words, at the time when the user instructed to execute the transmission job, the network cable of the MFP 100 may have been disconnected.

FIG. 10C illustrates an example of the screen displayed when a cause “destination is incorrect” is selected in the list 1001. The screen displays the transmission destination 503 and a QR code (registered trademark) 1003 of an online manual, in addition to the information displayed on the screen in FIG. 10B. By displaying the transmission destination 503, the user can check whether the destination is correct. Displaying the QR code 1003 of the online manual enables the user to check detailed handling methods described in the online manual. In the case of the cause “unable to connect to the network” in FIG. 10B, because the handling method is clear and there is no corresponding description in the online manual, the QR code 1003 of the online manual is not displayed.

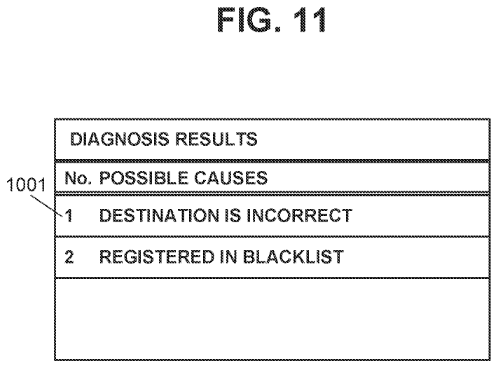

In a case where the error diagnosis control unit 410 determines that link down has not occurred in step S902 (NO in step S902), the error diagnosis control unit 410 causes the operation control unit 401 to display the error list generated in step S901 on the operation unit 102. FIG. 11 illustrates an example of the screen, and the cause “unable to connect to the network”, which is a cause of the link-down state of the network, is not displayed.

Although the list is generated such that the handling method relating to the link down is preferentially displayed in step S903, the preferential display of a handling method other than the handling method relating to the link down may also be determined. In FIG. 10A, the causes “unable to connect to the network”, “destination is incorrect”, and “registered in a blacklist” are displayed in the list of handling methods. In the blacklist, destinations are registered in advance, and data is prevented from being transmitted to the registered destinations. When a destination registered in the blacklist is set as the destination, the cause “unable to connect to the network” is displayed with the highest priority, and the cause “registered in the blacklist” is displayed with the second highest priority. When the destination is not registered in the blacklist, the cause “destination is incorrect” is preferentially displayed next to the cause “unable to connect to the network”.

In the present exemplary embodiment, the method for setting the priority order and controlling the display order in the list of handling methods has been described. Alternatively, another method in which the characters of the cause with a high priority is highlighted by bolding or the like may be used.

According to the process described above, when the network is in a link-down state, the cause indicating that the network is in a link-down state is displayed at the top of the list when the error diagnosis is performed. As a result, the convenience at the error handling is improved.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-098346, filed Jun. 18, 2024, which is hereby incorporated by reference herein in its entirety.

What is claimed is:

1. An information processing apparatus comprising:
a network device, wherein the information processing apparatus executes transmission jobs that transmit data to other apparatuses based on instructions from a user by using the network device;
one or more memories storing instructions; and
one or more processors capable of executing instructions causing the information processing apparatus to:
display, for each of the transmission jobs execution of which is instructed, information relating to each of the transmission jobs;
receive, of all pieces of the information, selection of a piece of information relating to a transmission job in which an error has occurred;
diagnose the transmission job associated with the received information; and
display a plurality of handling methods for the transmission job as a result of the diagnosis,
wherein a handling method relating to link down is preferentially displayed, in the displaying of the plurality of handling methods.

2. The information processing apparatus according to claim 1, wherein, in a case where an error relating to link down has not occurred in the transmission job relating to the received information, the handling method relating to link down is not displayed, in the displaying of the plurality of handling methods.

3. The information processing apparatus according to claim 1,
wherein three or more handling methods are displayed, in the displaying of the plurality of handling methods, and
wherein another handling method based on the received information is preferentially displayed next to the handling method relating to link down, the another handling method being different from the handling method relating to link down.

4. The information processing apparatus according to claim 1, wherein the information relating to the transmission job is displayed in response to reception of a diagnosis content.

5. The information processing apparatus according to claim 1, wherein the transmission job is a job for transmitting image data obtained by reading a document with a scanner included in the information processing apparatus to the another apparatus.

6. A control method of an information processing apparatus that executes transmission jobs for transmitting data to other apparatuses via a network based on instructions from a user, the control method comprising:
displaying, for each the transmission jobs execution of which is instructed, information relating to each of the transmission jobs;
receiving, of all pieces of the information, selection of a piece of information relating to a transmission job in which an error has occurred;
diagnosing the transmission job associated with the received information; and
displaying a plurality of handling methods for the transmission job as a result of the diagnosis,
wherein a handling method relating to link down is preferentially displayed, in the displaying of the plurality of handling methods.
